(19) United States
(12) Patent Application Publication
(10) Pub. No.: US 2017/0228701 A1
(43) Pub. Date: Aug. 10, 2017

(54) Creating and Managing Optimal Routes for Users' Day

(71) Applicant: Intel Corporation, Santa Clara, CA (US)

(72) Inventors: Michal Wosk, Tel-Aviv (IL); Gil Sharon, Even-Yehuda (IL); Merav Greenfeld, Ness-Ziona (IL); Gili Ilan, Hertzeliya (IL); Ronen Soffer, Tel-Aviv (IL); Amir Yissaschar, Qiryat Ono (IL)

(21) Appl. No.: 15/280,432

(22) Filed: Sep. 29, 2016

Related U.S. Application Data
(60) Provisional application No. 62/291,978, filed on Feb. 5, 2016.

(51) Int. Cl. G06Q 10/10; G01C 21/36; G01C 21/34

(52) U.S. Cl. CPC G06Q 10/1097; G01C 21/3484; G01C 21/3691

(57) ABSTRACT

Systems, apparatuses and methods may provide for identifying a plurality of user intents and identifying user state data. Additionally, a time sorted list of intents may be generated based on the plurality of user intents and the user state data, wherein the time sorted list of intents defines a user route with respect to a particular day. In one example, the sorted list of intents is dynamically updated in response to a change in the user state data, a change in the plurality of user intents and/or a conflict between two or more of the plurality of user intents.

### CROSS-REFERENCE TO RELATED APPLICATIONS

The present application claims the benefit of priority to U.S. Provisional Patent Application No. 62/291,978 filed on Feb. 5, 2016.

### TECHNICAL FIELD

Embodiments generally relate to automated daily planning. More particularly, embodiments relate to creating and managing optimal day routes for users.

### BACKGROUND

The day-to-day lives of individuals may include a variety of “intents”: places to be, tasks to complete, calls to make, meetings to attend, commutes and travel to conduct, workouts to complete, friends to meet, and so forth, wherein some intents may be considered “needs” and other intents may be considered “wants”. The intents may be stored and managed in many digital and non-digital sources, such as, for example, calendars, communications with others, task lists, e-mails, call logs, routine behaviors, and more.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an apparatus according to an embodiment;

FIG. 2 is an illustration of an example of a time sorted list of intents and an unsorted list of candidate intents according to an embodiment; and

FIG. 3 is a flowchart of an example of a method of operating an apparatus according to an embodiment; and

FIG. 4 is a block diagram of an example of a computing system according to an embodiment.

### DESCRIPTION OF EMBODIMENTS

The complexity of managing the day of an individual may involve a smart system that integrates intents in order to present the user with a clear picture of the upcoming day. This system may be constantly aware of the state of the user (e.g., the user's position/location, activity, actions, availability, and\or any other contextual information that can be inferred from various existing and not existing sensors and user data sources) in order to help the user navigate through the day. The system may also change the route of the day according to the user's actual actions and locations.

The system may apply the basic principles of navigation systems to the realm of personal assistants. A navigation system may know what the user intent is, and in a turn-by-turn fashion it may follow and guide the user through the optimal route that it generated, until the user reaches the destination. The system described herein may be regarded as a navigation system for the user's entire day: generating an optimal route for the user's day, and turn-by-turn navigating the user through it, until the user ends the day, happy, satisfied and enjoying a fulfilling sense of accomplishment.

This disclosure enables users to easily navigate through their daily intents. It provides the following solutions to humans:
Full representation of the day and the planned activities throughout it in order to manage it. Existing solutions such as calendar agendas may provide meeting times and locations but do not present relevant information for the day such as: driving times between meetings, which other tasks may conflict with these meetings or drives, understanding of where the day begins and ends, etc.
A system that is aware of the user's context and the dynamic changes in the user's day. Existing solutions such as daily agendas may present the user with updates and changes in the day's meeting, but they do not take into account the changes in the user's context and its influence on the day's planned event. For example, taking into account if the user is usually driving or walking to meetings, applying traffic conditions to understand if the user is going to arrive to a meeting on time or going to be late, etc.
Ability to view the day's commutes and travels in order to help the user to plan ahead. Existing solutions may make sure that the user will leave on time by providing “time to leave” alerts only for the next upcoming event. When the user has a sequence of upcoming events, however, these systems may not provide the user with the ability to plan ahead and foresee the day (e.g., how late the user can stay at work today without being late to the party after work).
Optimization in fulfilling intents (e.g., needs and wants) for time, space and other considerations. Existing systems such as calendars and task lists may not provide the ability to combine meetings, tasks, calls and other intents into the schedule in a way that presents a prioritized, optimized, “route” for the day. Techniques described herein may provide a rich understanding of intents in a way that allows the system to suggest personalized and effective solutions for conflicts, allocate tasks into free slots and make proactive suggestions to increase productivity along the day.

The present system may provide a layer of understanding above the user's existing intent sources, such as: calendar, task list, e-mail, messaging applications, etc. The system may analyze these intents and create an optimal route for the user to easily achieve as many of them as possible. It does so using the following capabilities:
Integration of multiple intent sources: The system may concentrate the intents from the various distributed sources into a singular view representing the user's day. The intent sources might include calendars, task lists, e-mails, call logs, text messages and other communications, behavioral patterns and routines.
Deep understanding of user intents: The system analyzes different intent types such as: being in a place, meeting a person, completing a task, making a call, attending a meeting, etc. The system analyzes each intent and extracts the “W4H components” for each intent: what type of intent it is, where the intent is taking place, when is the optimal time to fulfill it, who are the stakeholders of the intent and how it will be fulfilled (means of transport, online vs. face-to-face meeting, etc.). This understanding enables the system to handle each intent in the way that fits it best.
Building a timeline of semantic times: The system creates a timeline of intents ordered by the time in which each of them is planned to be fulfilled. Users may refer to intents using both specific times (“I want to be home at 7 pm”) and semantic times related to the day (“I need to send the e-mail next time I'm connected”, “I will call John on the drive home”, etc.). The system links both types of intents into a singular sequenced timeline reflecting the user's day.
Anchoring of intents onto the user's day using smart suggestions: By combining the deep understanding of each intent, with the user's plan for the day and the user's context, the system is able to offer smart suggestions of what time in the day and which locations are optimal to fulfill the intent. The system takes into account the user's planned locations, calendar availability, planned drives, proximity to POIs, means of transport (MOT), stakeholders and their availability, opening hours, etc., and according to them offers the points in the day that are relevant for the intent fulfillment. For example, if the user has an intent to buy a particular medication, the system may offer the user to fulfill the intent at a pharmacy close to a planned meeting location, if there is enough time before the meeting.
Context aware system that dynamically updates the user's day: The system constantly listens to changes in the user's intents and in the user's context and updates the route of the day accordingly. This context awareness includes an understanding of being late to a meeting and providing relevant assistance for this situation, an understanding that a user is in a meeting and the implication that it has on other intents (phone calls that cannot be taken at this time, for example), an understanding that the user is on the way to a location and offering things that the user can do on the way, and more.

The present system may provide the following benefits:
Sequence of intents into a “route” for the day: the system described herein obtains the various intents from the user's intent sources and constructs from them an optimized route that will enable fulfilling as many of them as possible throughout the day.
While some of the existing solutions may combine multiple intent types into one view (such as meetings, tasks and driving tasks), these solutions lack the fundamental advantage that the system described herein provides: a sequence of the day's intents into a route for the day, that follows the user throughout the day and changes with the location and activity changes along the day.
Ordering intents according to their semantic time: In contrast to existing time-management solutions that order intents solely by their chronological times, the system described herein orders the intents according to their semantic times and locations in addition to chronological times. By ordering intents taking into account semantic times and locations the system enables:

(a) Presenting a sequence of locations planned to visit on that day;

(b) Calculating commute times between locations and a prospective view on when to leave each location to be on time at the next one;

(c) Linking intents to the correct semantic part of the day.

For example, if the user has an intent to call John when the user arrives at a particular hotel, the system links the intent to a meeting in the particular hotel later in the day. If the user has an intent to stop at the flower shop on the next drive, the intent will be linked to the user's drive home.

By that, the system described herein creates a useful combination of a to-do list and a calendar, combining both time based and context based “anchors”—and that is in itself aware of time, space and other constraints and considerations. This advantage is an added value that other existing solutions do not provide.
Deep understanding of intents and their sources: managing intents in an optimal way requires a system that has a deep understanding of the various intents types, their sources and their semantic meaning. The system described herein analyzes the intents by breaking them down into their basic ingredients and aims to understand: what the intent type is, where it is planned to take place, who the relevant stakeholders may be, how it will probably be fulfilled and what constraints the intents have may have. In doing so, the system provides suggestions for optimal fulfillment of intents along the route of the day. For example, if a user has an intent to attend a call meeting, the system may suggest that the user make the call on the way to the next meeting by understanding that (a) the intent is a call, (b) the meeting does not have location constraints, and (c) the user should be on the way to another meeting at this time in order to arrive on time.

By deeply understanding each intent, the system optimizes the user's day and assists in fulfilling as many of the day's intents as possible. Existing solutions lack this deep understanding of what the intent actually means, and therefore provide only partial assistance regarding them. For example, existing solutions may usually treat call meetings in the same way they would treat other To-Do items, and would not suggest tailored assistance to this type of intent, such as allowing the user to attend the meeting during the drive (e.g., via hands-free communication).
Intent linkage and hierarchy: In addition to the deep understanding of the components of the intents, the system also understands correlated intents and their hierarchy. Most user intents are conjunct to other intents; for example, if an individual has an intent to go to the gym after work, the individual may also have linked a secondary intent related to that primary intent such as to take the gym bag with the individual in the morning or to call the gym to sign up for the class the day before. The system described herein understands that intents are highly related to one another, and that the relationship between intents may receive hierarchical treatment. The system (1) links secondary intents to primary ones and (2) updates the relevance of linked intents due to changes in the primary ones. For example, if the user withdraws the intent to go to the gym, the system will also understand that the secondary intents (“take the gym bag”, “call to sign up for class”) are no longer relevant. Existing solutions lack this deep understanding of intents and their relationship with other intents. Therefore, they may provide limited assistance in managing and fulfilling the day's intents while also resulting in a more intrusive user experience that prompts the user with irrelevant alerts during the day (for example: alerting the user to take the gym bag even though the gym workout was cancelled).
Relationship between static & dynamic elements: the present system may provide a holistic experience combining static intents (such as calendar meetings, time based tasks, etc.) with the dynamic elements that update accordingly. Dynamic elements in the user's day such as means of transport, changes in availability, traffic conditions, opening hours of POIs (points of interest), etc., are updated throughout the day based on the user's context and status. Continuous analysis of the user's intents and status with regard to them enables providing real time assistance and information regarding these intents. For example, if the user has an intent to stop by the postal office on a specific day, the system may prompt the user to leave work earlier than usual due to the postal office's closing hours. Another example: When a user has an intent to be at a location at a specific time, and due to changes in traffic the user is about to be late, the system offers the user assistance that is tailored to the new user state (of being late) such as: notifying others about the user being late or offering to reschedule the meeting.

Existing solutions lack this capability. Some solutions may trigger a “Time to leave” reminder, but will not move the meeting to a “late” state, providing tailored assistance for this state, which is different than the assistance given when the user is on time.
“Turn-by-turn” assistance throughout the day: resembling a vehicular navigation system, the system described herein aims to assist the user throughout all the “turns” included in the user's day. The system described herein escorts the user throughout the day, providing relevant information and actions to fulfill the user's intent at the relevant turns of the day. For example, the system will alert the user about an intent to print concert tickets when the user arrives to the office, to fill up gas when the starts driving or to marinate the steaks as soon as the user arrives home. The system encourages the user to fulfill intents by (a) reminding the user about the intent at the most relevant time and (b) offering contextual “snoozing” options for postponing the intent to a later timing. As opposed to existing solutions, which may enable postponing intents to a later time, the system described herein provides context aware options for postponing an intent. For example, if the user sets up an intent to send the mail from work, and as soon as the user arrives the user has to go into a meeting, the system will offer to snooze the reminder until after the meeting. If the user has an intent to call someone when the user drives, but for some reason the user cannot make the call while driving, the system may suggest that the user take the call after the user parks the car. Helping the user to postpone the intent to a relevant time, and not a constant one (e.g., 5 minutes, 10 minutes, etc.), increases the odds of the intent to be eventually fulfilled and results with better assistance for the user.

Prospective view: The ability to plan ahead may be integral to effective time management. Existing solutions such as calendar agendas may provide users with views of future meetings, events and tasks. When one turns to these existing solutions in order to plan ahead, however, the user does not receive a full, accurate picture of future intents and the effect they have on the user's planned day. For example, an individual might not appreciate that travel from one place to another may cause a conflict between meetings under conventional systems. The system described herein provides a full prospective view of a user's day, showing all of the day's intents and a future state at a given time. For example, when viewing a future day, the system might present the user with a full route of the day: planned drives between locations, when to leave each location to get to the next, intents linked along the day and possible conflicting meetings due to travels, locations and times. In addition, the system may present the user with the future state of the user at a given time, for example: “at 6 pm you will be on the way to yoga class”, “You will be at weekly status meeting at this time”, etc. These abilities enable further assistance in planning ahead, provide the user with a fuller picture of how a future day is planned to look and assists in preventing conflicts between intents.

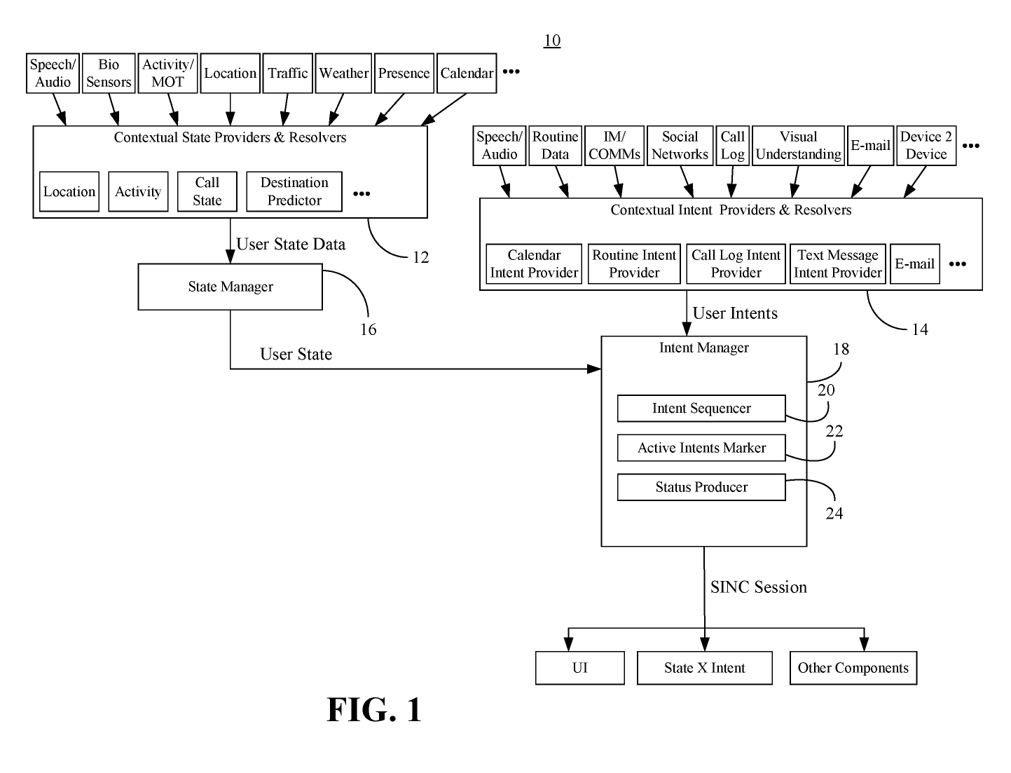

FIG. 1 shows a detailed description of a day management apparatus 10 that creates an optimal route for users in order to navigate throughout the day.

State providers 12: location, activity (driving, walking, stationary), call state and destination predictor are in charge of monitoring and tracking changes in the user state (each one in the part of the state that it manages). Any other contextual state that can be inferred from existing or future sensors may be used as a state provider. Whenever relevant data is tracked it may be moved forward to a state manager 16.

State manager 16 collects the data provided by the state providers 12 and generates a “user state” entity out of them. The user state entity represents the user's current contextual state description that is later used by an intent manager 18. Whenever the state manager 16 recognizes a change in the user state entity, it may trigger an event of “user state changed”, which can later lead to re-calculation of the user's day.

Intent providers 14: calendar, routine, call log, text messages, e-mails, or any other providers that can infer intents from existing or future modules or sensors. These providers 14 are in charge of monitoring and tracking changes in the user's intents (each one in the intents that it manages). Whenever relevant data is tracked it is moved forward to the intent manager 18.

Intent manager 18 executes the following three phases, which will be elaborated on further:

Intent sequencer 20—receives intents from the various intent providers 14, orders them and identifies conflicts between them.

Active intents marker 22—receives the sequence of intents produced by the intent sequencer 20 and identifies whether an intent is currently active using the user state received from the state manager.

Status producer 24—receives the sequence of intents with the active intents marked by the active intents marker 22 and calculates the status of each intent with regard to the user state received by the state manager 16.

The output of the intent manager 18 is a SINC (State Intent Nerve Center) session object that is displayed to users in the UI (user interface) as a “timeline”, and is also used by additional components in the system. Whenever the intent manager 18 recognizes a change in the user intents, it triggers re-execution of the above three phases and re-calculation of the SINC Session object. Also, whenever the state manager 16 triggers a “user state changed” event, the intent manager 18 triggers re-execution of the above three phases and re-calculation of the SINC Session object. Also, the state manager 16 can mark timestamps in which re-calculation is due, according to its understanding of the day and not due to external triggers. For example: The intent manager 18 might set a re-calculation for the next ten minutes when it identifies that a meeting is about to end in ten minutes, which will cause a change in the entire day.

The illustrated intent sequencer 20 operates in the following way:

Grouping—At the first stage, the intent sequencer 20 divides the intents it received from the intent Providers 14 into three types of intents:

“time and location” intents

“time only” intents

“unanchored” intents

Sequencing—Then, the intent sequencer 20 may use the “time & location” intents to generate a directed weighted non-cyclic graph that includes the minimal collection of routes that cover the maximum number of intents. This may be done using a routing algorithm such as, for example, a “Minimum Paths, Maximum Intents” (MPMI) solution.

Anchoring—Then, the illustrated intent sequencer 20 takes the “unanchored” intents group and selects from them those intents that depend on moving between points, such as, but not limited to:

“Arrive to a location” intents

“Leave location” intents

“On the way to a location” intents

“On the next drive” intents

“On the next walk” intents

The intent sequencer 20 then attempts to anchor the selected intents onto vertices or edges on the graph that was generated in the sequencing phase.

Conflicts identification—The intent sequencer 20 iterates on the graph and identifies conflicts. A conflict is a case in which there are two intents that do not have any route between them. These conflicts may be marked on the graph.

Projection—In order to create a timeline, each intent in the graph is paired with a physical time, so that the intents on the graph may be ordered according to their timing.

Completion—On the resulting graph, the group of “time only” intents are added to the graph according to their timing, so that a full timeline with all intents that can be anchored in it is generated.

The active intents marker 22 receives the output graph from the intent sequencer, may operate in the following way:

Based on the intents graph and data from the state manager 16, the active intents marker 22 applies a set of predefined rules on each intent in order to determine whether the user is engaged in this intent at the moment. These rules are specific for each intent type on the graph. For example: For a meeting intent in the graph, the active intents marker 22 determines whether the current time is the time of the meeting, and if the current user location is the location of the meeting. If both parameters are positive, the meeting intent is marked as active.

The illustrated status producer 24 receives the intents graph with the active intents marked on it and creates a status line for each of these intents. The status line is generated based on the user state information, crossed with the information about the intent. For example:

For a meeting intent, when the user is in the meeting location but the meeting has not started yet according to its time, the status producer 24 will produce the following status: “In meeting location, waiting for the meeting to start”.

For a meeting intent, when the user is driving and it is detected that the user is on the way for the meeting location but the distance in ETA (estimated time of arrival) will make the user late for the meeting: “On the way to <meeting location>, will be there <x> minutes late”.

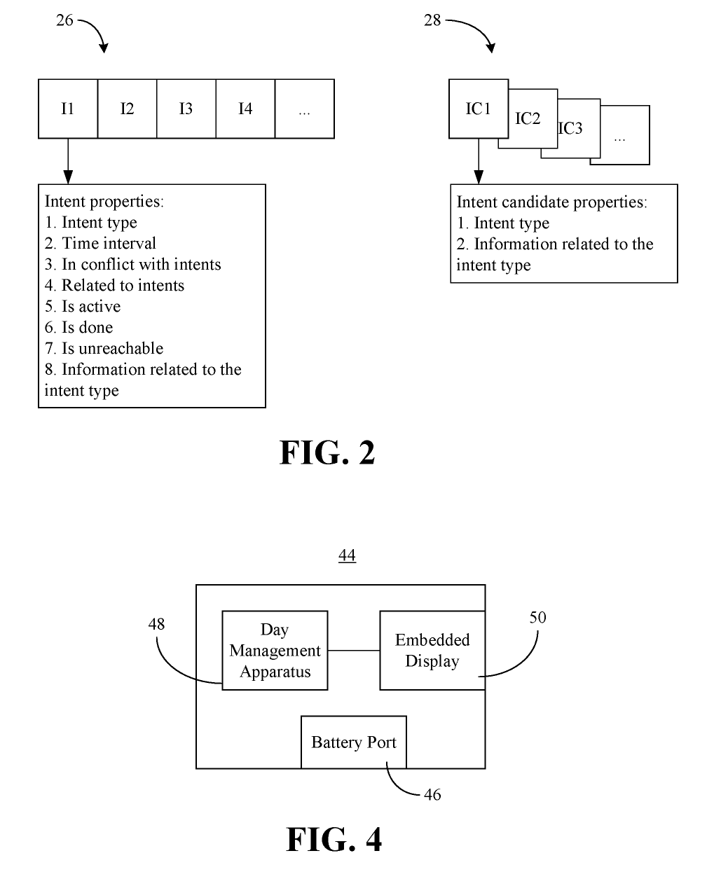

The output result may be an object called: SINC Session, described in FIG. 2. This session is later displayed to the user using UI components, or further used in the system to create more advanced views on the user's time such as: short summary of the user's upcoming event, watch face display UI component, and so forth. The SINC Session is comprised of the following entities:

A sorted list of intents 26: This list 26 is sorted according to each intent's time interval. Each intent in this list is composed of the following intents properties:

Time interval—The time span in which the intent will be active. According to this property the intents in the list 26 are sorted.

Intent type—Meeting intent, call intent, task intent, travel intent, etc.

In conflict with intents—ID's (identifiers) of other intents in the list 26, which are in time and location conflict with this intent.

Related to intents—ID's of other intents in the list 26, on which the intent depends, for example: Call intent that will be executed on the next travel is dependent on the next travel intent.

Is active—Determination if the intent is active in the current user state, as determined by the active intents marker 22 (FIG. 1).

Is done—Determination if the intent is completed according to the current user state, as determined by the intent manager 18 (FIG. 1).

Information related to the intent type—All other enriching information that is related to the intent and is constructed according to the intent type. For example, for a call intent: which number the user should call when fulfilling this intent. Or for example: For a travel intent, which means of transport the user will use when fulfilling this task.

An unsorted list of intent candidates 28: This list includes all the intents that the intent manager could not anchor into the sorted intents list 26. Therefore, they are not enriched with the data on the time interval, since the intent manager 18 (FIG. 1) could not determine when this intent will be fulfilled. Whenever the state manager 16 (FIG. 1) re-calculates the SINC Session, the intent candidates are considered again as candidates to be anchored to the sorted list of intents 26.

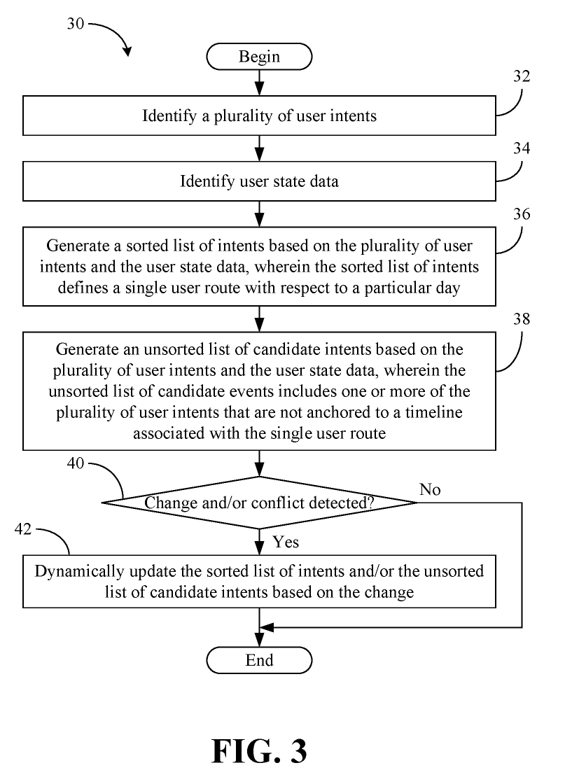

FIG. 3 shows a method 30 of operating an apparatus. The method 30 may generally be implemented in a client system such as, for example the apparatus 10 (FIG. 1), already discussed. More particularly, the method 30 may be implemented in one or more modules as a set of logic instructions stored in a machine- or computer-readable storage medium such as random access memory (RAM), read only memory (ROM), programmable ROM (PROM), flash memory, etc., as configurable logic such as, for example, programmable logic arrays (PLAs), field programmable gate arrays (FPGAs), complex programmable logic devices (CPLDs), as fixed-functionality logic hardware using circuit technology such as, for example, application specific integrated circuit (ASIC), complementary metal oxide semiconductor (CMOS) or transistor-transistor logic (TTL) technology, or any combination thereof.

Illustrated processing block 32 provides for identifying a plurality of user intents, wherein user state data may be identified at block 34. Block 36 may generate a time sorted list of intents based on the plurality of user intents and the user state data, wherein the time sorted list of intents defines a user route with respect to a particular day. The time sorted list of intents may be ordered according to one or more semantic times associated with the plurality of user intents. In one example, block 36 includes documenting (e.g., marking) a relationship between two or more of the plurality of user intents. As already noted, the relationship may provide a hierarchical linkage between two or more of the plurality of user intents. Block 36 may also provide for outputting the time sorted list as a session object (e.g., SINC session). Additionally, illustrated block 38 generates an unsorted list of candidate intents based on the plurality of user intents and the user state data, wherein the unsorted list of candidate intents includes one or more of the plurality of user intents that are not anchored to a timeline associated with the user route.

A determination may be made at block 40 as to whether a change in the user state data, a change in the plurality of user intents, a conflict between two or more of the plurality of user intents, etc., has been detected. If so, illustrated block 42 dynamically updates the sorted list of intents and/or the unsorted list of candidate intents in response to the change/conflict. Otherwise, the method 30 may bypass block 42 and terminate.

FIG. 4 shows a computing system 44 that includes a battery port 46 to provide power (e.g., obtained from a battery) to the system 44, a day management apparatus 48 and an embedded display 50. The system 44 may be part of a tablet computer, convertible tablet, smart phone, personal digital assistant (PDA), wearable computer, mobile Internet device (MID), media player, etc., or any combination thereof. The day management apparatus 48, which may implement one or more aspects of the method 30 (FIG. 3), may function similarly to the apparatus 10 (FIG. 1). Thus, the day management apparatus 48 may include logic to identify a plurality of user intents, identify user state data, and generate a time sorted list of intents based on the plurality of user intents and the user state data, wherein the time sorted list of intents is to define a user route with respect to a particular day. Moreover, the embedded display 50 may visually present the time sorted list of intents.

The logic may be implemented in instructions, configurable logic, fixed-functionality logic hardware, etc., or any combination thereof. Logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.). Accordingly, the generation of time sorted lists of intent as described herein may improve computer functionality to the extent that the computing system 44 operates more efficiently and provides an enhanced user experience.

### Additional Notes and Examples

Example 1 may include a user-based system comprising a battery port to provide power to the system, logic, implemented at least partly in one or more of configurable logic or fixed-functionality logic hardware, to identify a plurality of user intents, identify user state data, and generate a time sorted list of intents based on the plurality of user intents and the user state data, wherein the time sorted list of intents is to define a user route with respect to a particular day an embedded display to visually present the time sorted list of intents.

Example 2 may include the system of Example 1, wherein the logic is to dynamically update the sorted list of intents in response to one or more of a change in the user state data, a change in the plurality of user intents or a conflict between two or more of the plurality of user intents.

Example 3 may include the system of Example 1, wherein the logic is to generate an unsorted list of candidate intents based on the plurality of user intents and the user state data, wherein the unsorted list of candidate intents is to include one or more of the plurality of user intents that are not anchored to a timeline associated with the user route.

Example 4 may include the system of any one of Examples 1 to 3, wherein the logic is to document a relationship between two or more of the plurality of user intents, and wherein the time sorted list of intents is to be generated based on the relationship.

Example 5 may include the system of Example 4, wherein the relationship is to provide a hierarchical linkage between the two or more of the plurality of user intents.

Example 6 may include a day management apparatus comprising logic, implemented at least partly in one or more of configurable logic or fixed-functionality logic hardware, to identify a plurality of user intents, identify user state data, and generate a time sorted list of intents based on the plurality of user intents and the user state data, wherein the time sorted list of intents is to define a user route with respect to a particular day.

Example 7 may include the apparatus of Example 6, wherein the logic is to dynamically update the sorted list of intents in response to one or more of a change in the user state data, a change in the plurality of user intents or a conflict between two or more of the plurality of user intents.

Example 8 may include the apparatus of Example 6, wherein the logic is to generate an unsorted list of candidate intents based on the plurality of user intents and the user state data, wherein the unsorted list of candidate intents is to include one or more of the plurality of user intents that are not anchored to a timeline associated with the user route.

Example 9 may include the apparatus of any one of Examples 6 to 8, wherein the logic is to document a relationship between two or more of the plurality of user intents, and wherein the time sorted list of intents is to be generated based on the relationship.

Example 10 may include the apparatus of Example 9, wherein the relationship is to provide a hierarchical linkage between the two or more of the plurality of user intents.

Example 11 may include the apparatus of any one of Examples 6 to 8, wherein the time sorted list is ordered according to one or more semantic times associated with the plurality of user intents.

Example 12 may include the apparatus of any one of Examples 6 to 8, wherein the logic is to output the time sorted list as a session object.

Example 13 may include a method of operating a day management apparatus, comprising identifying a plurality of user intents, identifying user state data, and generating a time sorted list of intents based on the plurality of user intents and the user state data, wherein the time sorted list of intents defines a user route with respect to a particular day.

Example 14 may include the method of Example 13, further including dynamically updating the sorted list of intents in response to one or more of a change in the user state data, a change in the plurality of user intents or a conflict between two or more of the plurality of user intents.

Example 15 may include the method of Example 13, further including generating an unsorted list of candidate intents based on the plurality of user intents and the user state data, wherein the unsorted list of candidate intents includes one or more of the plurality of user intents that are not anchored to a timeline associated with the user route.

Example 16 may include the method of any one of Examples 13 to 15, further including documenting a relationship between two or more of the plurality of user intents, wherein the time sorted list of intents is generated based on the relationship.

Example 17 may include the method of Example 16, wherein the relationship provides a hierarchical linkage between two or more of the plurality of user intents.

Example 18 may include at least one computer readable storage medium comprising a set of instructions which, when executed by a computing device, cause the computing device to identify a plurality of user intents, identify user state data, and generate a time sorted list of intents based on the plurality of user intents and the user state data, wherein the time sorted list of intents is to define a user route with respect to a particular day.

Example 19 may include the at least one computer readable storage medium of Example 18, wherein the instructions, when executed, cause the computing device to dynamically update the sorted list of intents in response to one or more of a change in the user state data, a change in the plurality of user intents or a conflict between two or more of the plurality of user intents.

Example 20 may include the at least one computer readable storage medium of Example 18, wherein the instructions, when executed, cause the computing device to generate an unsorted list of candidate intents based on the plurality of user intents and the user state data, wherein the unsorted list of candidate intents is to include one or more of the plurality of user intents that are not anchored to a timeline associated with the user route.

Example 21 may include the at least one computer readable storage medium of any one of Examples 18 to 20, wherein the instructions, wherein the instructions, when executed, cause the computing device to document a relationship between two or more of the plurality of user intents, and wherein the time sorted list of intents is to be generated based on the relationship.

Example 22 may include the at least one computer readable storage medium of Example 21, wherein the relationship is to provide a hierarchical linkage between the two or more of the plurality of user intents.

Example 23 may include the at least one computer readable storage medium of any one of Examples 18 to 20, wherein the time sorted list is to be ordered according to one or more semantic times associated with the plurality of user intents.

Example 24 may include the at least one computer readable storage medium of any one of Examples 18 to 20, wherein the instructions, when executed, cause the computing device to output the time sorted list as a session object.

Example 25 may include a day management apparatus comprising means for identifying a plurality of user intents, means for identifying user state data, and means for generating a time sorted list of intents based on the plurality of user intents and the user state data, wherein the time sorted list of intents defines a user route with respect to a particular day.

Example 26 may include the apparatus of Example 25, further including means for dynamically updating the sorted list of intents in response to one or more of a change in the user state data, a change in the plurality of user intents or a conflict between two or more of the plurality of user intents.

Example 27 may include the apparatus of Example 25, further including means for generating an unsorted list of candidate intents based on the plurality of user intents and the user state data, wherein the unsorted list of candidate intents includes one or more of the plurality of user intents that are not anchored to a timeline associated with the user route.

Example 28 may include the apparatus of any one of Examples 25 to 27, further including means for documenting a relationship between two or more of the plurality of user intents, wherein the time sorted list of intents is generated based on the relationship.

Example 29 may include the apparatus of Example 28, wherein the relationship is to provide a hierarchical linkage between two or more of the plurality of user intents.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A system comprising:
a battery port to provide power to the system;
logic, implemented at least partly in one or more of configurable logic or fixed-functionality logic hardware, to:
identify a plurality of user intents;
identify user state data; and
generate a time sorted list of intents based on the plurality of user intents and the user state data, wherein the time sorted list of intents is to define a user route with respect to a particular day
an embedded display to visually present the time sorted list of intents.

2. The system of claim 1, wherein the logic is to dynamically update the sorted list of intents in response to one or more of a change in the user state data, a change in the plurality of user intents or a conflict between two or more of the plurality of user intents.

3. The system of claim 1, wherein the logic is to generate an unsorted list of candidate intents based on the plurality of user intents and the user state data, wherein the unsorted list of candidate intents is to include one or more of the plurality of user intents that are not anchored to a timeline associated with the user route.

4. The system of claim 1, wherein the logic is to document a relationship between two or more of the plurality of user intents, and wherein the time sorted list of intents is to be generated based on the relationship.

5. The system of claim 4, wherein the relationship is to provide a hierarchical linkage between the two or more of the plurality of user intents.

6. An apparatus comprising:
logic, implemented at least partly in one or more of configurable logic or fixed-functionality logic hardware, to:
identify a plurality of user intents;
identify user state data; and
generate a time sorted list of intents based on the plurality of user intents and the user state data, wherein the time sorted list of intents is to define a user route with respect to a particular day.

7. The apparatus of claim 6, wherein the logic is to dynamically update the sorted list of intents in response to one or more of a change in the user state data, a change in the plurality of user intents or a conflict between two or more of the plurality of user intents.

8. The apparatus of claim 6, wherein the logic is to generate an unsorted list of candidate intents based on the plurality of user intents and the user state data, wherein the unsorted list of candidate intents is to include one or more of the plurality of user intents that are not anchored to a timeline associated with the user route.

9. The apparatus of claim 6, wherein the logic is to document a relationship between two or more of the plurality of user intents, and wherein the time sorted list of intents is to be generated based on the relationship.

10. The apparatus of claim 9, wherein the relationship is to provide a hierarchical linkage between the two or more of the plurality of user intents.

11. The apparatus of claim 6, wherein the time sorted list is ordered according to one or more semantic times associated with the plurality of user intents.

12. The apparatus of claim 6, wherein the logic is to output the time sorted list as a session object.

13. A method comprising:
identifying a plurality of user intents;
identifying user state data; and
generating a time sorted list of intents based on the plurality of user intents and the user state data, wherein the time sorted list of intents defines a user route with respect to a particular day.

14. The method of claim 13, further including dynamically updating the sorted list of intents in response to one or more of a change in the user state data, a change in the plurality of user intents or a conflict between two or more of the plurality of user intents.

15. The method of claim 13, further including generating an unsorted list of candidate intents based on the plurality of user intents and the user state data, wherein the unsorted list of candidate intents includes one or more of the plurality of user intents that are not anchored to a timeline associated with the user route.

16. The method of claim 13, further including documenting a relationship between two or more of the plurality of user intents, wherein the time sorted list of intents is generated based on the relationship.

17. The method of claim 16, wherein the relationship provides a hierarchical linkage between two or more of the plurality of user intents.

18. At least one computer readable storage medium comprising a set of instructions which, when executed by a computing device, cause the computing device to:
identify a plurality of user intents;
identify user state data; and
generate a time sorted list of intents based on the plurality of user intents and the user state data, wherein the time sorted list of intents is to define a user route with respect to a particular day.

19. The at least one computer readable storage medium of claim 18, wherein the instructions, when executed, cause the computing device to dynamically update the sorted list of intents in response to one or more of a change in the user state data, a change in the plurality of user intents or a conflict between two or more of the plurality of user intents.

20. The at least one computer readable storage medium of claim 18, wherein the instructions, when executed, cause the computing device to generate an unsorted list of candidate intents based on the plurality of user intents and the user state data, wherein the unsorted list of candidate intents is to include one or more of the plurality of user intents that are not anchored to a timeline associated with the user route.

21. The at least one computer readable storage medium of claim 18, wherein the instructions, wherein the instructions, when executed, cause the computing device to document a relationship between two or more of the plurality of user intents, and wherein the time sorted list of intents is to be generated based on the relationship.

22. The at least one computer readable storage medium of claim 21, wherein the relationship is to provide a hierarchical linkage between the two or more of the plurality of user intents.

23. The at least one computer readable storage medium of claim 18, wherein the time sorted list is to be ordered according to one or more semantic times associated with the plurality of user intents.

24. The at least one computer readable storage medium of claim 18, wherein the instructions, when executed, cause the computing device to output the time sorted list as a session object.
